(19) United States
(12) Patent Application Publication
(10) Pub. No.: US 2008/0316306 A1
(43) Pub. Date: Dec. 25, 2008

(54) Robot System Equipped with a Tool, Camera and Light Source

(76) Inventors: Hardy Burkle, Stuttgart (DE); Uwe Haas, Plochingen (DE); Claus Lorcher, Leinfelden-Echterdingen (DE)

Correspondence Address: AKERMAN SENTERFITT, P.O. BOX 3188, WEST PALM BEACH, FL, 33402-3188, US

(21) Appl. No.: 10/588,557

(22) PCT Filed: Jan. 13, 2005
(86) PCT No.: PCT/EP2005/000241

§ 371 Date: Aug. 4, 2006

(30) Foreign Application Priority Data
Feb. 5, 2004 (DE) 10 2004 005 574.2

(51) Int. Cl. B25J 19/04; B25J 15/00

(52) U.S. Cl. 348/86; 901/47; 901/31; 901/14

(57) ABSTRACT

A robot system comprises one or more tools (5, 15), a camera (9) and a light source (13), which can be moved independent of the camera (9), in order to illuminate the field of vision of the camera from different directions.

### CROSS-REFERENCE TO RELATED APPLICATION

This application is a national stage of PCT/EP20005/000241 filed Jan. 13, 2005 and based upon DE 10 2004 005 574.2 filed Feb. 5, 2004 under the International Convention.

### BACKGROUND OF THE INVENTION

1. Field of the Invention

The present invention relates to a robot system that is provided with a light source and a camera for detecting geometric properties of a workpiece, and at least one tool in order to perform manipulations on the workpiece. Such a robot system is disclosed, for example, in JP-A-07-28 68 20.

2. Description of the Related Art

In this known robot system, a light course and a camera are mounted in common, but independently of a tool, at the tip of an articulated robot arm and can be positioned in space with a plurality of degrees of freedom such that the light source illuminates a workpiece to be machined and the camera records pictures of the workpiece.

In this known system, the camera and light source cannot be moved relative to one another. It is true that with the aid of a projector the light source can optionally illuminate different strip-shaped zones in the field of view of the camera even without a movement of the light source, but the direction from which a specific point of an object in the field of view is irradiated is always the same as long as the light source and camera do not move jointly. This can render it very difficult to evaluate the images recorded by the camera, particularly when the regions of an object that are of interest are shaded by objects situated between the light source and them.

### SUMMARY OF THE INVENTION

It is an object of the invention to provide a robot system in which it is possible to implement optimum viewing conditions for a camera for the purpose of detecting a workpiece in conjunction with different geometries of the workpiece or an environment in which it is installed.

The object is achieved by virtue of the fact that the light source and the camera can be moved independently of one another in order to illuminate the field of view from different directions. That is to say, when a region of a workpiece that is of interest is poorly illuminated in the given position of the light source and camera with reference to one another, the light source can be moved independently of the camera in order to improve the illumination of this region. The variability of the alignment of the light source and camera relative to one another also facilitates the process of obtaining 3D information from an image recorded by the camera, since the change of the shape of shadows that is associated with a variation in the direction of irradiation onto an object permits an electronic unit for image evaluation that is possibly connected to the camera to distinguish shadow zones from surfaces that are intrinsically dark.

A subassembly that comprises the camera and the light source as well as at least a first adjusting device for moving camera and light source relative to one another can preferably be moved by a second adjusting device with reference to a common base. Thus, for example, a standard position of the camera and light source with reference to one another that supplies useful images for most geometries of a workpiece to be examined can be set at the first adjusting device, and it is possible to operate only the second adjusting device in order to vary the field of view or viewing angle of the camera. Since this camera and light source move jointly, apart from parallax effects the light source remains aligned with the field of view of the camera without the need to control the movement of the former expressly.

Of the camera and light source one is preferably firmly connected to the second adjusting device, such that its position and orientation is given completely and exclusively by the position of the second adjusting device, whereas the position of the light source with reference to the camera is defined by the position of the first adjusting device.

Furthermore, a subassembly that comprises the camera and at least one of the tools as well as at least one third adjusting device for moving camera and tool relative to one another can be moved by a fourth adjusting device with reference to a common base. Here, as well, of the camera and tool in each case one is preferably firmly connected to the fourth adjusting device, such that its its position and orientation is given completely and exclusively by the position of the fourth adjusting device, and the position of the third adjusting device fixes the position of the camera and tool with reference to one another.

The tools of the inventive robot system preferably include at least a gripping tool and further tool for carrying out any desired machining step on the workpiece. The gripping tool, which is to be understood here as encompassing any desired tool for temporarily holding, and, if appropriate, moving a workpiece, can be used, in particular, for the purpose of gripping and (at least temporarily) removing obstacles that otherwise prevent free access of the light from the light source, the view of the camera or the access of the further tool to a site of interest on the workpiece.

Whereas the mobility of the further tool with reference to the camera can be restricted, it is desirable for the gripping tool and the camera to have as high a number of degrees of freedom as possible in the relative movement so that the gripping tool can remove obstacles without impairing the field of view of the camera. Consequently, the gripping tool and the camera are preferably mounted on mutually independent moveable carriers, in other words the number of degrees of freedom with which the gripping tool and the camera can be moved with reference to one another is greater than the number of

### BRIEF DESCRIPTION OF THE DRAWINGS

Further features and advantages of the invention emerge from the following description of exemplary embodiments with reference to the attached figures. In the drawing:

FIG. 1 shows a first exemplary embodiment of an inventive robot system in which a camera, light source and tool are respectively carried by a robot arm mounted on a stationary base;

FIG. 2 shows a modification of the robot system from FIG. 1, equipped with two tools;

FIG. 3 shows a second refinement of a robot system equipped with two tools; and

FIG. 4 shows a third refinement of the robot system, in which robot arms carrying the camera, light source and tool are mounted on a gantry.

### DETAILED DESCRIPTION OF THE INVENTION

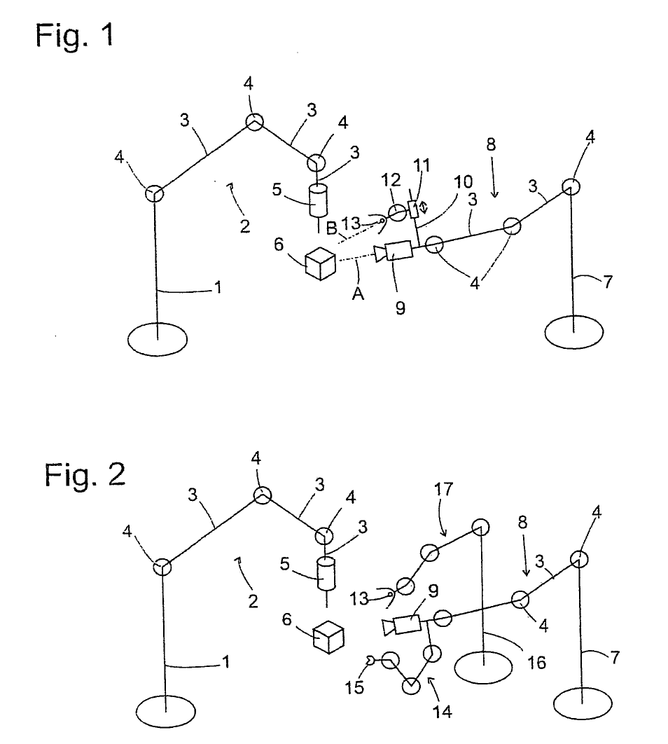

FIG. 1 shows a schematic of the fundamental principle of the invention. A stationary base 1 mounted, for example, on the floor of a workshop carries a robot arm 2 with a number of articulated members 3. Articulations 4 between the base 1 and the members 3 or between two members 3 each have at least one, preferably a number of degrees of rotational freedom and can be driven by a control device (not illustrated) in order to position and to swivel a tool 5 mounted at the end of the arm 2 in all three spatial positions and doing so as desired within the scope of the range of the arm 2. The tool 5 can be of any desired known suitable type of machining a workpiece 6, for example a gripper, a drill, a milling machine, a welding tool, etc.

A second base 7 carries a second robot arm 8 whose design can be the same as that of the robot arm 2. Mounted at the free end of the robot arm 8 is a camera 9 that can be positioned as desired in space under the control of the control device and can be aligned with the workpiece 6 in order to supply images of the workpiece 6 to the control device. Projecting from the camera 9 is a rail 10 on which a carriage 11 can be moved under the control of the control device. The carriage 11 carries a light source 13 by means of a likewise controllable articulation 12. The light source 13 can be a simple spotlight with reflectors such as is indicated in the figure that has a cone of light, with a principal ray direction B, which can be aligned with the workpiece 6, by displacing the carriage 11 and swiveling the articulation 12, from the various angles relative to the direction of view of the camera 9. The rail 10 can preferably be rotated about the optical axis A of the camera 9 such that not only is the angle between the principal ray direction B of the light source 13 and the optical axis A of the camera 9 variable, but also the position of the plane defined by these two directions. Whilst the robot arm 8 constitutes a first adjusting device with which the control device can displace camera 9 and light source 13 in a fixed relationship to one another as regards position, the carriage 11 and the articulation 12 are part of a second adjusting device, which in the event of a given position and orientation of the camera by the illumination of the field of view of the camera 9 can be varied in order to find that illumination which respectively enables details of the workpiece 6 that are of interest to be detected most effectively.

A preferred development of the robot system is shown in FIG. 2. Parts of this robot system that already correspond with reference to parts described in FIG. 1 bear the same reference numerals and are not described anew if there are no differences from the configuration of FIG. 1. The free end of the robot arm 8, which carries the camera 9, here forms the base of a third robot arm 14 at whose free end the gripping tool 15 is located. The gripping tool 15 can have in the usual way a number of fingers, that can be moved relative to one another, for clamping the workpiece 6 or a part thereof or, when the part to be gripped is ferromagnetic, it can include an electromagnet, and it can have a suction cup connected to a vacuum source or any other desired device for temporarily keeping hold of an object. When the control device identifies in the image supplied by the camera 9 an object that obstructs the view onto the site on the workpiece 6 that is of interest, or which shades this site, it drives the gripping tool 15 so as to remove the relevant object temporarily, for example so as to push aside a hose connected to the workpiece has been inspected, the plug-in connector is plugged in again by the gripping tool 15.

The light source 13 is mounted here on a third stationary base 16 by means of a fourth robot arm 17 and, by contrast with the gripping tool 15, therefore does not move in a fashion coupled to the camera 9. It therefore does not restrict the mobility of the robot arm 14 around the camera 9. Alternatively, the gripping tool 15 and the light source 13 could, of course, both be mounted on the robot arm 8 in a moveable fashion with reference to the camera 9.

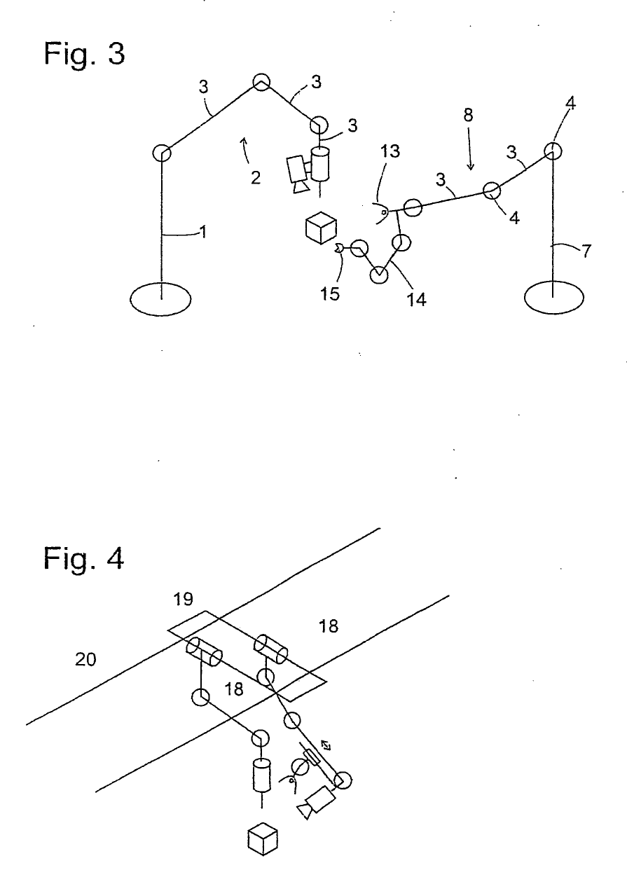

In the configuration shown in FIG. 3, the tool 5 and the camera 9 are mounted at the free end of the first robot arm 2. The camera 9 can be firmly connected to the tool 5 in a fashion permanently aligned with a tip of the tool 5 that interacts with the workpiece. The light source 13 and the gripping tool 15, which is connected thereto via the robot arm 14, are arranged on the second robot arm. As long as the arm 14 is not moved, the gripping tool 15 follows every movement of the light source, and is thus always located in the vicinity of the light source where it is required in order to remove an obstruction between the light source and the surface, observed by the camera 9, of the workpiece 6 or between this surface and the camera 9.

FIG. 4 shows a schematic of a robot system in the case of which the arm 2 carrying the tool 5, and the arm 8 carrying the camera 9 and the light source 13 are mounted on rails 18 of a crab 19 that for its part can move on rails 20 of a gantry superstructure. The design and mode of operation of the arms 2, 8 is the same here as in the case of FIG. 1. If desired, however, the number of the articulations 4 in the case of the arms 2, 8 of this exemplary embodiment can be reduced by comparison with FIG. 1, since the mobility along the rails 18, 20 adds two degrees of freedom to the translation.

The robot arms could also be mounted jointly on a vehicle in accordance with a modification that is not shown.

Now that the invention has been described, We claim:

1. A robot system equipped with one or more tools (5, 15), a camera (9) and a light source (13) for illuminating the filed of view of the camera (9), wherein the light source (13) and the camera (9) can be moved independently of one another in order to illuminate the filed of view from different directions.

2. The robot system as claimed in claim 1, wherein a subassembly that comprises the camera (9) and the light source (13) as well as at least a first adjusting device (10, 11, 12) for moving camera (9) and the light source (13) relative to one another can be moved by a second adjusting device (8) with reference to a common base.

3. The robot system as claimed in claim 2, wherein one of the camera (9) and light source (3) is firmly connected to the second adjusting device (8).

4. The robot system as claimed in claim 2, wherein a subassembly that comprises the camera (9) and at least one of the tools (15) as well as at least one third adjusting device (14) for moving camera (9) and tool (15) relative to one another can be moved by a fourth adjusting device (8) with reference to a common base.

5. The robot system as claimed in claim 4, wherein one of the camera (9) and tool (15) is firmly connected to the fourth adjusting device (8).

6. The robot system as claimed in claim 4, wherein the tools (5, 15) include at least a gripping tool (15) and a further tool (5).

7. The robot system as claimed in claim 6, wherein the number of degrees of freedom with which the gripping tool (15) and the camera (9) can be moved with reference to one another is greater than the number of degrees of freedom of the camera (9) and the gripping tool (15) with reference to a stationary part of the robot system.

8. A robot system equipped with
one or more tools (5, 15) for manipulation of a workpiece (6),
a camera (9) for detecting the geometric characteristics of the workpiece, the camera having a field of view, and
a light source (13) for illuminating the filed of view of the camera (9), wherein the light source (13) and the camera (9) are moveable independently of one another in order to illuminate the filed of view from different directions.

9. The robot system as claimed in claim 8, wherein a subassembly that comprises the camera (9) and the light source (13) as well as at least a first adjusting device (10, 11, 12) for moving camera (9) and the light source (13) relative to one another is moveable by a second adjusting device (8) with reference to a common base.

10. The robot system as claimed in claim 9, wherein one of the camera (9) and light source (3) is firmly connected to the second adjusting device (8).

11. The robot system as claimed in claim 9, wherein a subassembly that comprises the camera (9) and at least one of the tools (15) as well as at least one third adjusting device (14) for moving camera (9) and tool (15) relative to one another can be moved by a fourth adjusting device (8) with reference to a common base.

12. The robot system as claimed in claim 11, wherein one of the camera (9) and tool (15) is firmly connected to the fourth adjusting device (8).

13. The robot system as claimed in claim 11, wherein the tools (5, 15) include at least a gripping tool (15) and a further tool (5).

14. The robot system as claimed in claim 13, wherein the number of degrees of freedom with which the gripping tool (15) and the camera (9) can be moved with reference to one another is greater than the number of degrees of freedom of the camera (9) and the gripping tool (15) with reference to a stationary part of the robot system.
